(19) United States
(12) Patent Application Publication
(10) Pub. No.: US 2003/0189480 A1
(43) Pub. Date: Oct. 9, 2003

(54) Remote actuation system, device and method

(76) Inventor: Laurence Hamid, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/115,232

(22) Filed: Apr. 4, 2002

(51) Int. Cl. H04Q 1/00; G05B 19/00

(52) U.S. Cl. 340/5.52; 340/5.64

(57) ABSTRACT

In a remote keyless system, a fob is disclosed, which provides the user with selective control of elements in a property in concert with a controller at the property, while the fob is nearby the property. In one example the fob is a wireless portable terminal, which accepts a biometric information having been presented by a user. A transducer generates a digital data based on the biometric information. A data store receives and stores the digital data generated by the transducer. A transmitter is responsive to the digital data having been stored in the data store for broadcasting a signal, at a predetermined frequency and modulated by the stored digital data for reception by the controller, after an interval of time corresponding to a time for the user carrying the wireless portable terminal to have traveled a distance, such that the user may present a predetermined biometric characteristic at a convenient place and time prior to the time of a consequent effect thereof at said property.

The invention is in the field of security and control of property. More particularly the invention relates to a user convenience and security feature in association with a portable remote control device and a property, such as a motor vehicle, a residence and the like.

### BACKGROUND OF THE INVENTION

Various locking devices intended to prevent a door or other object from being opened, moved, or operated, without use of a corresponding key are in common daily usage. Among various examples are small portable electronic devices which function as a key in concert with a corresponding lock controller associated with a secured property. One or more persons in possession of a corresponding portable electronic device may gain entry to the secured property by actuating the device when it is within operating range of a sensory element of the lock controller. A very common example of usage of remote entry devices is that of a remote keyless entry feature, now popular for automobiles.

An automobile equipped for remote actuatable functions typically includes a controller, powered from a battery in the automobile, which continually monitors a preselected frequency in the electromagnetic spectrum. A portable electronic device includes a transmitter and one or more keys or pushbuttons, any of which when depressed causes a particular code to be broadcast by a low power signal at the selected frequency. Such a portable electronic device is sometimes referred to as a fob. Among a population of automobiles with similar lock controllers, only a controller and a fob having been initialized with a selected coded signal will operate to effect a locking function, unlocking function or some other selected function. In operation the feature is dependent upon the user of the fob being close enough to the automobile for the lock controller to detect any broadcast of the coded signal. Usually the range of operation is limited to not more than a hundred meters or so.

Keyless entry systems may provide remote actuation of a multitude of functions in association with the secured property or vehicle. For example the fob may present the user with many control functions via a display scroll or via several keys. Such functions are well known and may include but are not limited to, remote start, find me or “panic”, unlocking or locking of a door or doors, release of a truck lid or boot, and opening of a sliding door. It is essential that control functions such as remote start and find me, be available while the fob is distantly adjacent, say a distance of up to 100 meters for example, while in the interest of security, activation of vehicle entry functions be effected only while the user is close by. For example, a vehicle may be singled out from a multitude of vehicles in a parking lot, by generating an instruction which is transmitted from the fob for causing the vehicle to sound its horn or flash its lights so that the user may more readily identify their vehicle at some distance. This function may also be useful at a distance both for discouraging a potential tamperer, if one is observed by the user. In contrast it is preferred that vehicle entry functions including the unlocking of a door or doors be effected only when the user is about to enter the vehicle, so as to minimize any potential for mischief or an unwelcome intrusion. Of course the prudent user governs their use of the fob accordingly.

If a user while approaching their dwelling or vehicle is encumbered with baggage or parcels manipulating the fob can be no more expeditious than using a typical key. Similarly, during inclement or extreme weather conditions the requirement of manipulating the fob to select the desire function through bulky gloves or mittens, or while struggling with a wind blown umbrella can be an unwelcome challenge. If the keyless entry system is functional over a sufficient range, the desired feature may be effected while the user is yet indoors or otherwise within a more agreeable environment. However, in some locations a vehicle unattended and unlocked for several minutes or more is an open invitation to mischief, particularly if the remote start feature has been activated. Furthermore it has been demonstrated by practical experience that a fob with several pushbuttons can be accidentally actuated while being carried in a user's pocket. On more than one occasion, someone in their residence or at some other location remotely nearby their automobile, has found an unexpected control event has occurred. An unintentional remote trunk opening, sunroof opening, or sliding door opening is at least inconvenient. During a blizzard for example some hours after the event, the user upon approaching the automobile may find the trunk lid up in the wind or the sliding door open and the interior half full of wind packed snow. If this unfortunate event went undetected for a day or more the trunk light or interior light may have drained the vehicle battery. Be it at a user's convenience or by accident or mistake, early or unintentional actuation of a remote entree feature exposes the user to potential property damage or property loss. Furthermore once a user experiences an incident of unintentional actuation the user may suffer stress and anxiety, which may only be alleviated by having the keyless entry feature disabled.

Solutions directed to avoiding premature activation of vehicle access have involved limiting the range of communication between the user's fob and the controller in the vehicle. This solution however is not suitable for functions such as remote start and find me. Neither is it suitable for permitting control manipulation of the fob prior to vehicular or residence entry while for example sheltered from inclement weather or other intimidating or extreme conditions.

One solution directed toward avoiding accidental activation of vehicle access substitutes a biometric sensing device for the pushbuttons. Though this does not solve the problems associated with being encumbered by packages or wearing gloves and so forth, it does prevent most accidental actuations.

A biometric sensing device, responsive to a user's fingerprint for example, is by nature most unlikely to be mistakenly or accidentally activated. However it is common knowledge to those of skill in the art in electronic biometric information sensing and analysis that a significant problem exists in sensing fingerprints in different conditions. A wet fingertip is imaged differently by a contact imager than a dry fingertip. Even more significant are problems associated with imaging of an overly dry fingertip such as that which may result during extremely cold weather. Unfortunately, cold weather is a reality to contend with in many locations as is humidity. It would be advantageous to provide a fob wherein some of the problems with current contact imaging devices are mitigated.

### OBJECT OF THE INVENTION

It is an object of the invention to provide remote keyless features in association with a vehicle or other property wherein accidental or premature activation of a feature which would jeopardize security of the vehicle is avoided.

It is a further object of the invention to provide remote keyless features in association with a vehicle or other property while avoiding user stress which may be associated with having to manipulate a control fob while the user is exposed to intimidating or extreme conditions or the user is otherwise preoccupied.

It is yet a further object of the invention to distinguish features which are appropriate for immediate actuation and security features appropriate for a delayed actuation, such delay being appropriate for a user's progress toward a door, hatch, window or other portal of potential entry before actuation for permitting entry takes effect.

### SUMMARY OF THE INVENTION

In accordance with the invention there is provided a wireless portable terminal for operation in concert with a controller within a property, the terminal comprising:

a biometric transducer for accepting a biometric information sample provided by a user and for generating digital data based on at least a characteristic of the biometric information sample;

a data store for storing the digital data generated by the biometric transducer; and,

a transmitter being responsive to the digital data having been stored in the data store for transmitting a signal, at a predetermined frequency and modulated based on the stored digital data for reception by the controller, after an interval of time corresponding to a time for the user carrying the wireless portable biometric terminal to have traveled a distance, such that the user may present a predetermined biometric characteristic at a convenient place and time prior to the time of a consequent effect thereof at said property.

In accordance with another aspect of the invention there is provided a method of operating a wireless portable terminal for communicating with a controller within a property, upon a presentation of a user's biometric characteristic thereto, comprising the steps of:

accepting a biometric information having been presented by a user;

generating a digital data representative of the biometric information;

storing the digital data having been generated; and, responsive to the digital data having been stored and after an interval of time corresponding to a time for the user of the entry terminal to have traveled a distance, broadcasting a signal, at a predetermined frequency being modulated based on the stored digital data for reception by the controller, such that the user may present a predetermined biometric characteristic at a convenient place and time prior to the time of a consequent effect thereof at said property.

In accordance with the invention there is provided a wireless portable terminal for operation in concert with a controller within a property, the terminal comprising:

a transducer for accepting input data provided by a user and for generating digital data based on the input data;

a data store for storing the digital data generated by the biometric transducer; and, a transmitter being responsive to the digital data having been stored in the data store for transmitting a signal, at a predetermined frequency and modulated based on the stored digital data for reception by the controller, after an interval of time corresponding to a time for the user carrying the wireless portable biometric terminal to have traveled a distance, such that the user may present a predetermined biometric characteristic at a convenient place and time prior to the time of a consequent effect thereof at said property.

Various examples in accordance with the invention are useful in association with any of vehicles, fixed dwellings, commercial establishments and the like.

### BRIEF DESCRIPTION OF THE DRAWINGS

Example embodiments are discussed with reference to accompanying drawings in which:

FIG. 1 is a pictorial diagram illustrating an exemplary environments wherein the invention is useful;

FIG. 2 is a plan view diagram of a wireless portable terminal or fob which can be used in the environments illustrated in FIG. 1;

FIG. 3 is a schematic block diagram of an electronic circuit in the fob illustrated in FIG. 2;

FIG. 4 is a plan view diagram of another example of a fob which can be used in the environment illustrated in FIG. 1;

FIG. 5 is a schematic block diagram of an electronic circuit in the fob illustrated in FIG. 4;

FIG. 6 is a schematic block diagram of an example of an electronic circuit for use in a controller in association with a property in any of the environments in FIG. 1 and the fob illustrated in FIGS. 2 and 3;

FIG. 7 is a schematic block diagram of another example of an electronic circuit for use in a controller intended for use in associated with any of the environments in FIG. 1 and the fob illustrated in FIGS. 4 and 5;

FIG. 8 is a flow diagram illustrating a function of the fob in FIGS. 2 and 3;

FIG. 9 is a flow diagram illustrating a function of the electronic controller in FIG. 6;

FIG. 10 is a flow diagram illustrating in concert functions of a fob as for example illustrated in FIGS. 4 and 5 and an electronic controller as for example illustrated in FIG. 7;

FIGS. 11, is plan view diagram of a wireless portable biometric terminal in accordance with the invention and which can be used in the environments illustrated in FIG. 1;

FIG. 12 is an exemplary representation of a user's biometric characteristic to which the wireless portable biometric terminal illustrated in FIG. 11 is responsive for its operation;

FIG. 13 is an internal partial side view diagram of a wireless portable biometric terminal in accordance with the invention;

FIG. 14 is block schematic diagram of the wireless portable biometric terminal illustrated in FIG. 13;

FIG. 15 is a flow diagram illustrating a function of the wireless portable biometric terminal illustrated in FIGS. 13 and 14;

FIG. 16 is an internal partial side view diagram of the wireless portable biometric terminal illustrated in FIG. 11;

FIG. 17 is block schematic diagram of the wireless portable biometric terminal illustrated in FIG. 16; and

FIG. 18 is a flow diagram illustrating functions of the wireless portable biometric terminal illustrated in FIGS. 11, 16 and 17.

### DESCRIPTION OF THE EXAMPLE EMBODIMENTS

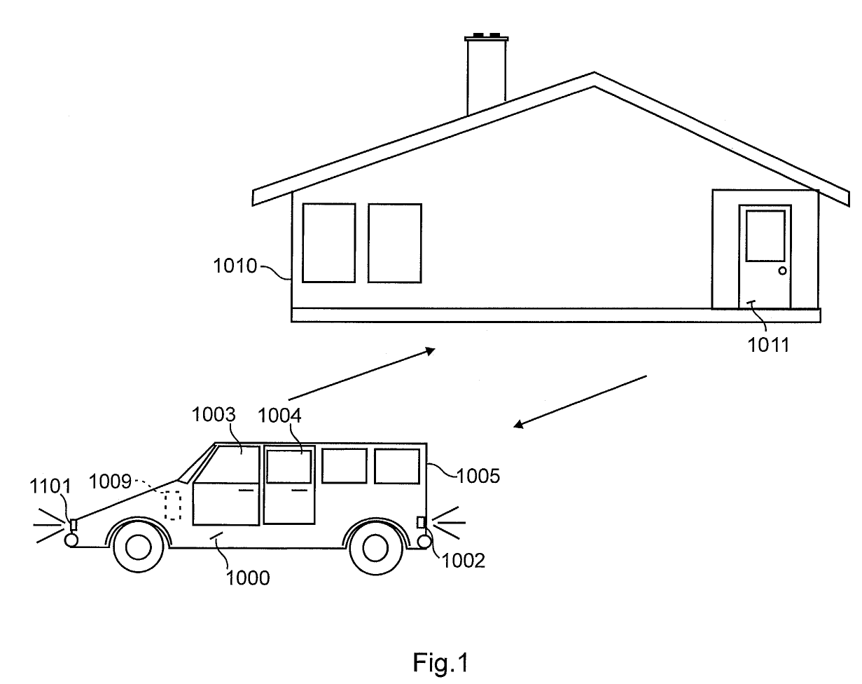

In FIG. 1, a typical remote or keyless entry feature is portrayed as being associated with two different properties, a vehicle 1000 and a dwelling 1010. The vehicle 1000 in this example is typical of a so-called minivan and shown to be parked in distant juxtaposition with the dwelling 1010. In this example the dwelling 1010 is a single unit dwelling having an entrance 1011 and is typical of those found in suburban areas. However, the dwelling 1010 might just as well be one of a multiple unit structure such as row housing or a multi-floor building. The vehicle 1000 is shown to have headlights 1001, tail lights 1002, a left front door or driver door 1003 and an opposite right front door, not visible. The vehicle 1000 also is shown to have a left rear sliding door 1004, a right rear sliding door which is hidden opposite, and a back door or tailgate 1005 is located as indicated. The vehicle 1000 may also optionally include a repeater transmitter 1009 shown in dotted outline and which is discussed later. The driver door individually or in concert with the other doors may be locked by a user in possession of a wireless terminal in the form of a fob provided for that purpose. The sliding and rear doors are optionally power operated and if so, may be individually actuated to either open or close from a distance in response to the user depressing appropriate fob input device in the form of pushbuttons in a typical well known manner. As shown, the vehicle 1000 is, at the moment, unoccupied while the user is somewhere nearby, in the dwelling 1010, perhaps demonstrating a panic feature in an attempt to demonstrate to friends or other acquaintance. However as before mentioned the operating feature may have been actuated unknowingly by an unintentional operation of the fob. The panic feature is well known to be useful for distinguishing the vehicle among a multitude of others and also useful for discouraging a tamperer or other mischievous person, from a location distantly adjacent the vehicle, thereby avoiding a direct encounter. Here as shown apparatus in the vehicle has responded to signaling by causing the headlights 1001, tail lights 1002 to flash as well as sounding the vehicles internal horn “BEEP BEEP”, for some time. Similarly a remote start feature is available. Other features not as readily available are known to include announcement of a verbal warning or some other action, as discouragement to a potential thief.

In a similar vein the dwelling 1010 may also be equipped with a controller for actuating indoor and outdoor illumination and for locking or unlocking the entrance 1011, as ordered from an associated user's fob. In distinction to features which are desirably actuated while the user is at some distance from the property, a feature specifically for unlocking and or opening of an entrance way, door, trunk or portal of any sort, can be restricted to actuation only when the user and hence the fob, carried by the user, is closely adjacent the portal, for example not more than a few steps away. Accordingly the user's fob and a corresponding controller provide a remote actuation system, for initiating a user's pushbutton selectable function related to a property, while the user is at the farthest, remotely or distantly adjacent the property, say 100 meters or so.

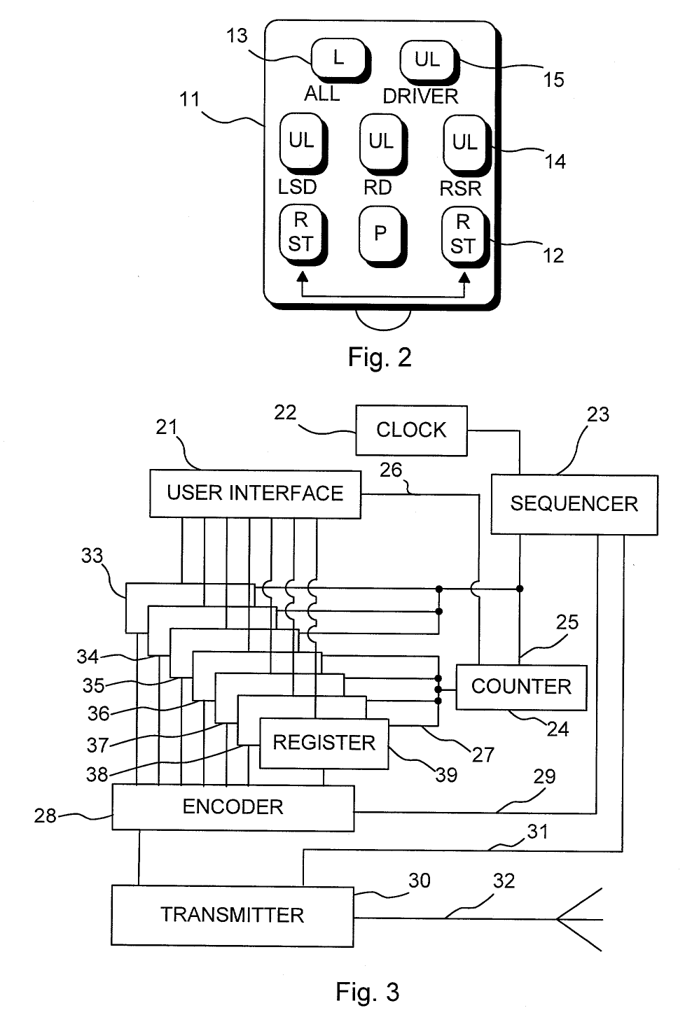

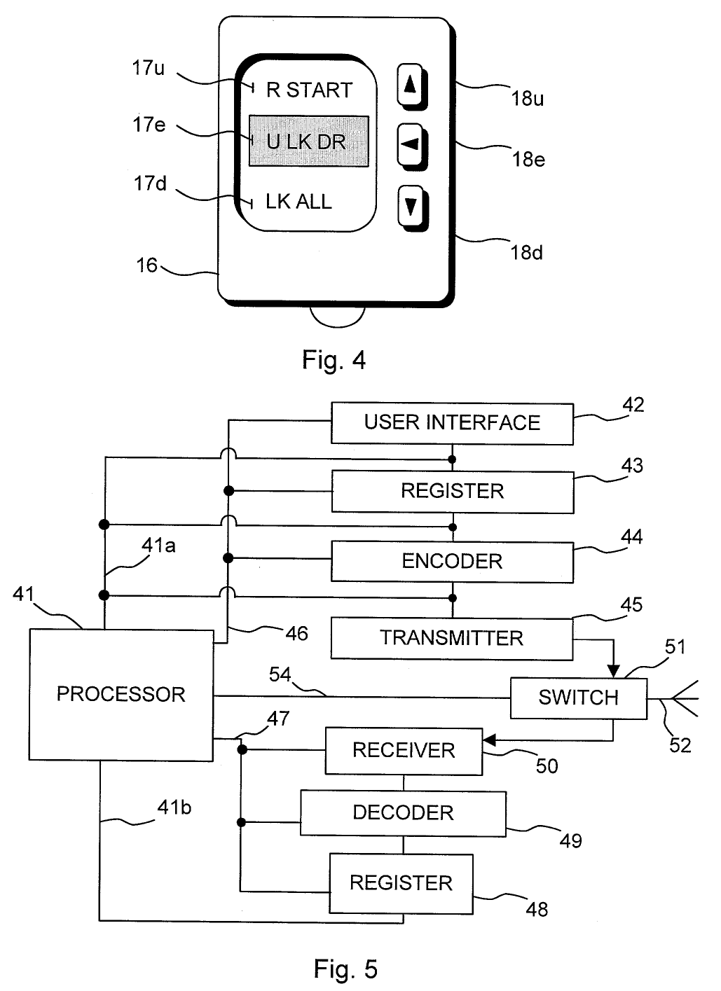

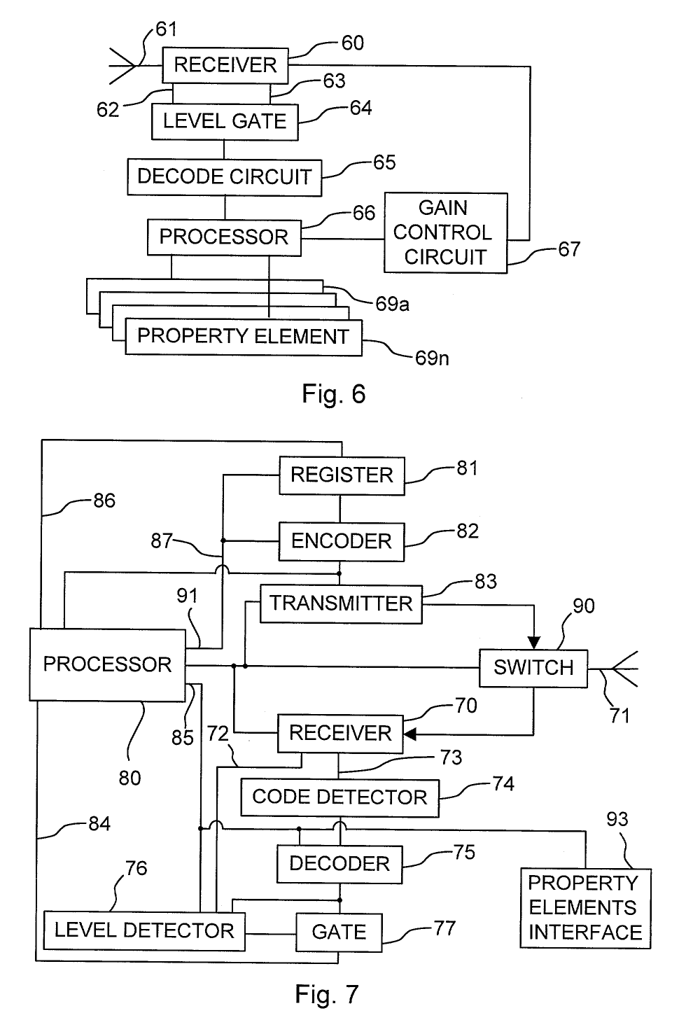

The vehicle 1000 is equipped with a convenience and security controller, some examples being shown in FIGS. 6 and 7. The controller is responsive to a wireless portable terminal as exemplified in any of FIGS. 2 and 4. The dwelling 1010 may be similarly equipped. The wireless portable terminal presents the user with a plurality of user selectable functions in relation to the property. Each function when selected is signaled for effecting such function at the property. A controller associated with the property is responsive to a reception of a signaled function having been signaled from the fob, for registering the selected function. In the event of a registered function being effective for providing the user with access to said property, such access is subsequently effected, contingent upon the reception or a subsequent reception having exhibited a predetermined parameter which is consistent with the fob signaling from a position within a few paces of a portal of the property. As is discussed in more detail in the following, the fob broadcasts frequently either responsive to interrogations from the controller or for a limited time after the user's selection of an access function. Hence an accidental depression of pushbutton on the fob is of no consequence to security while the user is unencumbered by any fob operational requirements as they approach either their vehicle 1000 or the entrance 1011 of their dwelling 1010.

Referring to FIG. 2 the fob includes a body 11, which internally houses electronic apparatus and carries labelled locations occupied by input devices in the form of pushbutton switches which are also labelled. The labels and pushbutton switches function as a user interface which permits the user to select individual features of the system. A pair of pushbutton switches labelled “R ST”, for remote start, reside in a row 12, separated by a pushbutton switch labelled “P” for panic. Depression of either the pair of R ST pushbutton switches, the P pushbutton switch or a pushbutton switch 13 labelled “L” for lock are intended to cause immediate initiation of a corresponding function at the user's vehicle. In contrast operation of any of the three pushbutton switches labelled “UL” for unlock, in a row 14, or the pushbutton switch 15 labelled “UL” are intended to cause registration of a corresponding function at the user's vehicle. Each of the pushbutton switches labelled UL is labelled on the fob as “LSD” for left side door; “RSD” for right side door; “RD” for right door; and “DRIVER” for driver's door. As is discussed in the following a controller in the user's vehicle is responsible for determining when and if the registered function is initiated.

In the following discussion of the schematic diagrams clock functions and supplies of power familiar to persons of typical skill in electronic technology and are not discussed in any detail except where such may aid in understanding. In FIG. 3, the internally housed electronic apparatus includes a clock 22, which provides periodic timing for the other elements in FIG. 3. A user interface 21 is representative of the pushbutton switches and labels carried by the fob 11. The user interface is connected to seven register elements 33-39. A sequencer 23 responds to the periodic timing signals by generating reset signals on a lead 25, encoder enable signals on a lead 29 and transmitter keying signals on a lead 31. A depression of any one of the pushbutton switches causes a corresponding one of the register elements to be set upon a coincident occurrence of a clock signal from the clock 22. An encoder 28 is connected to each of the register elements 33-39 and responds to an indication of one or more of the register elements 33-39 being in a set state while the encoder enable signal being asserted, via the lead 29, by sending a data word to a transmitter 30. The data word from the encoder 28 is representative of information for addressing a corresponding controller in the associated property, for example the controller in FIG. 6, as well as information being indicative of at least one of the pushbuttons having been depressed. The transmitter 30 is connected to broadcast via an antenna 32. The transmitter 30 is responsive to each assertion of the transmitter keying signal coincident with an assertion of a data word from the encoder 28, for broadcasting a signal modulated by the data word to include the representative information. The broadcast signal is intended for reception by the corresponding controller.

Of the seven register elements 33-39, three register elements 33-35 are associated with the lock all pushbutton switch L, the panic pushbutton switch P, and the pair of remote start pushbutton switches R ST, respectively. These pushbutton switches are for initiation of features of immediate actuation. The register elements 33-35 have reset leads connected in common to receive the reset signals from the sequencer 23 on the lead 25. The reset signals from the sequencer 23 in this example occur at half the rate of the clock signals generated by the clock 22 such that at least one data word is generated by the encoder before the register elements 33-35 are reset. As described the transmitter responds to the data word at least once by broadcasting. If broadcasting occurs more than once such is of little consequence.

The register elements 36-39 are associated with pushbutton switches labelled UL for unlock which are for initiation of features of unlocking actuation contingent upon the fob being within a few paces of the corresponding controller. The pushbutton switches labelled UL are each connected to a respective one of the register elements 36-39, each of which is connected in common to an output of a counter 24. The counter 24 is connected to the sequencer via the reset lead 25 and to the user interface 21 via a lead 26. The counter is arranged to be initiated by a depression of any of the pushbutton switches labelled UL. The counter generates a secondary reset signal on the lead 27 for the register elements 36-39 after a predetermined number of reset signal assertions have occurred on the lead 25. In one example if the reset signals from the sequencer are generated at 1 second intervals. A count of 255 can be decoded to generate the secondary reset signal after about 4 and a quarter minutes. Hence when one of the UL labelled pushbutton switches is depressed the transmitter is caused to broadcast the signal modulated by the data word at about 1 second intervals. As will be discussed later in more detail, the corresponding controller responds to a reception of the broadcast signal by monitoring a signal parameter, perhaps signal strength for example, until a characteristic of one of the broadcasts is consistent with the transmitter 30 being nearby, before actuating the user selected unlocking feature. Any depression of a UL labelled pushbutton switch initiates the four and a quarter minute time for broadcasts. A forced counter reset function is provided in association with the L labelled pushbutton switch, via a buffer 27a, whereby a reset signal is immediately applied to the register elements 36-39 to end all the selected entry functions which may be in progress in the event the L labelled pushbutton switch is depressed.

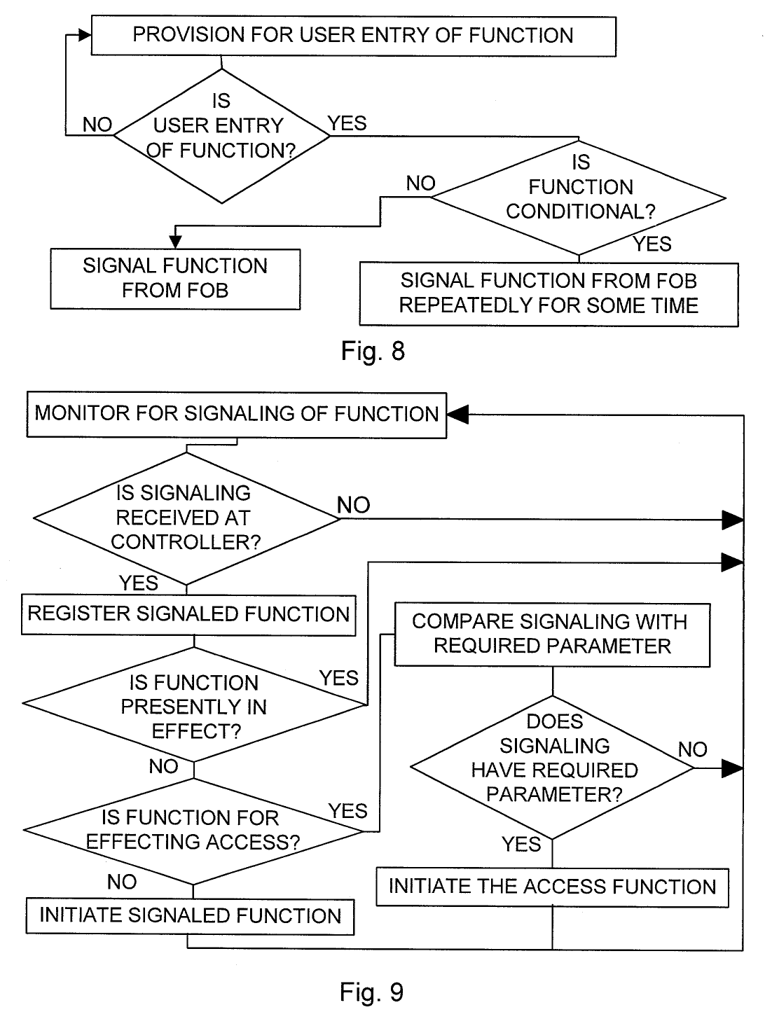

The forgoing discussion of the fob exemplified in FIGS. 2 and 3 illustrates a so called hardware embodiment, however it will be clear to persons skilled in the field of design of electronic controllers that the fob may also be provided, in an alternate embodiment, by the transmitter 30 and a small processor, suitably programmed. The flow chart in FIG. 8 summarizes a method by which the alternate embodiment functions. The method includes reading the user interface for a selected function. If no selection has occurred the user interface is read again and so on. If a selection has occurred the processor provides a coded word in a predetermined format for reception by the corresponding controller. The transmitter 30 is activated by the processor and broadcasts a signal modulated by the coded word. If the function is an unlocking function such function is deemed to be conditional. The conditional function is broadcast, optionally with reduced signal power, periodically over an interval of time.

The fob illustrated in FIG. 4 is provided in a housing 16 that carries a display intended for viewing by a user. The display includes upper, central and lower display portions labelled 17u, 17e and 17d respectively. During a function selection process, the user depresses either of pushbutton switches 18u and 18d to cause a display of available functions and to scroll either up or down through the available functions. To select a function, a pushbutton switch 18e, located between the pushbutton switches 18u and 18d, is depressed when the desired function is displayed opposite as shown against a lightly shaded background in the central display portion 17e. In this illustration the central display portion 17e is shown to be displaying a readout of unlock driver door as “ULK DR”, the upper display position 17u is shown to be displaying a readout of remote start as “R START”, and the lower display position 17d is shown to be displaying a readout of lock all doors as “LK ALL”.

Referring to FIG. 5, the electronic circuit resides within the housing 16 of the fob illustrated in FIG. 4. A processor 41 includes elements, not shown, typical of a small processor; an arithmetical logic unit, associated registers, and a memory including an instruction set stored therein for controlling operations of the fob. The processor is coupled via a control bus 46 to a user interface 42, a register 43, an encoder 44 and a transmitter 45, as shown. A bus 41a couples information from the user interface 42, the register 43 and the encoder 44 to the processor 41. The processor is coupled via a control bus 47 to a register 48, a decoder 49 and a receiver 50, as shown. A bus 41b couples information from the register 48 to the processor 41. A transmit receive switch 51 is controlled by the processor via a switch lead 54 to selectively connect either of the transmitter 45 or the receiver 50 to an antenna 52.

The user interface 42 includes the previously mentioned display and pushbutton switches 18d, 18e and 18u. The processor 41 responds to a momentary depression of either of the pushbutton switches 18d and 18u by causing a readout of the display to be incrementally shifted by one position in a corresponding down or up direction. An extended depression of either of the pushbutton switches 18d and 18u causes a series of incremental shifts in either of the corresponding directions for as long as the depression of the pushbutton switch continues. In one example subsequent to the user having selected a function by pressing the pushbutton switch 18e, confirmation of the corresponding controller having received the selected function is flashed momentarily on the display for the user's observation.

The register 43 responds to periodic latch signals from the processor 41 by registering the current state of each of the pushbutton switches 18u, 18e and 18d. When a depression of the pushbutton switch 18e occurs, the register 43 is set and indication of the function presently displayed in the central display portion of the display 17 is provided by the processor 41. The encoder 44 responds by generating a data word for reception by the corresponding controller. The data word includes information as to the selected function and may also include information as to any conditional function having been selected a short time before.

The transmitter 45 is subsequently activated by the processor 41 to broadcast a signal modulated with the data word from the encoder 44, for reception by the corresponding controller. During intervals when the transmitter 45 is inactive the receiver 50 may receive a signal having been broadcast from the corresponding controller. The receiver 50 demodulates any received signal and the decoder responds by generating a data word contingent upon the received signal having been broadcast with a predetermined code, unique to the corresponding controller. The data word is stored in the register 48 for subsequent use by the processor 41. The data word may for example include information confirming reception of a selected function, or a request for retransmissions of one or more previously selected functions.

In one example of the fob as represented in FIGS. 4 and 5, in the interest of conserving battery power, after a broadcast, the processor 41 activates the receiver for a period of time during which time if no signals of apparent origin at the corresponding controller are decoded, the processor shuts off power to all the circuit components including the display and ceases all functions except functions related to periodically scanning the pushbutton switches 18u, 18d and 18e. In an event where a pushbutton switch depression occurs, the processor restores power to the circuit components and causes the fob to resume its normal functions. Furthermore, in the event of the user having selected a conditional function or functions, the processor 41 either independently or responsive to signals from the corresponding controller causes the transmitter 45 to broadcast the selected conditional function or other prearranged signal. This broadcast occurs at intervals through a period of time, or repeatedly at a power being less than the power of a first broadcast. Alternatively the fob may from time to time broadcast a signal appropriately functional in a determination of the fob being physically located closely adjacent the corresponding controller.

In reference to FIG. 6, the illustrated electronic circuit provides an example of a corresponding controller intended for use with the fob illustrated in FIGS. 2 and 3. Various property elements 69a-69n are either directly or indirectly coupled with a processor 66 such that the particular function of each property element is dependent upon the processor for commencement of its function. The processor 66 includes elements, not shown, typical of a small processor, including an arithmetic logic unit, a memory and associated registers. A receiver 60 may receive signals broadcast from its corresponding fob via an antenna 61. If such signals are received, the receiver amplifies the received signals with a first predetermined gain and passes the amplified signals via a lead 62 to a level gate 64. The receiver also provides a delayed demodulated signal on a lead 63. If the amplified signals on the lead 62 are of sufficient signal level, consistent with the fob being within 10 metres or so, the level gate passes the delayed demodulated signal to a decoder circuit 65 which generates a corresponding decoded signal suitable for use by the processor 66. In the event the decoded signal indicates a user selection of a function for immediate actuation the processor so signals the appropriate property element. If the decoded signal indicates a user selection of a function for conditional actuation, the processor signals a gain control circuit 67 coupled to the receiver 60 by a control lead 68. The gain control circuit 67 causes the receiver 60 to operate with a lesser gain than normal. As discussed in relation to FIGS. 2 and 3 a selection specifying any unlocking function is conditional and is signalled by the fob a number of times. If a subsequent received signal is of a strength consistent with the fob broadcasting from within a few metres of the antenna 61 the processor responds by signalling the appropriate property element to perform the unlocking function and the gain control circuit is caused to restores the normal working gain of the receiver 60. The fob in concert with its corresponding property controller provides an improved level of security and convenience for the user but there are some limitations. For example if the user is distantly adjacent the property and selects one of the conditional functions, any subsequent selection which would normally cause immediate actuation of the function are not detected in the receiver 60 as it is operating at low gain. The processor 66 will only be responsive to non-conditional selections after it has restored the receiver 60 to operate with normal gain. Thus the user preferably remembers to select a vehicle function, such as remote start, or a dwelling function such as illuminate entrance, prior to selecting an unlock function.

Referring to the flow diagram of FIG. 9 a controller, for example as illustrated in FIG. 6, operates in accordance with the instruction set stored in the memory of the processor 66, by continuously monitoring for a signalling broadcast. When a broadcast signal is received the processor examines information in the broadcast for signalling valid for the controller, that is signalling which is likely to have been broadcast by the associated fob and not from any other source. If the processor determines valid signalling has been received—YES, a function represented by the signalling is registered as a signalled function by the processor. The processor then checks to determine if the signalled function is already in effect and if YES, it simply continues monitoring for a signalling broadcast. If however the determination is that the signalled function is not in effect—NO, the processor then determines if the signalled function is one which requires the unlocking or opening of a portal for providing access. If NO, activation of function of the property element identified in the signalled function is initiated by the controller and thereafter the controller continues monitoring for a signalling broadcast. If however the determination is YES, the signalled function is one which requires the unlocking or opening of a portal for providing access, the signalling is compared with a predetermined parameter, which is intended to be indicative of the fob being closely adjacent the antenna of the controller. If the predetermined parameter is present, the controller renders the property accessible and continues monitoring for a signalling broadcast.

The function of comparing the signalling with the required parameter and determining if the signalling either has, was, or is being broadcast, with or without the required parameter, may take many specific forms. As exemplified in FIG. 6, the processor 66 causes the receiver 60 to operate with a lower gain for either a period of time or until the broadcast signal is strong enough to be gated, which ever occurs first. As the associated fob repeatedly broadcasts a user selected access function, contingent upon the user approaching the antenna of the controller, the broadcast function will eventually be of sufficient signal strength to effect the access.

Referring to FIG. 7 the electronic circuit provides a corresponding controller intended for use in association with the fob illustrated in FIGS. 4 and 5. The controller includes an antenna 71 that is coupled to either of a receiver 70 or a transmitter 83 via a switch 90. A processor 80 includes elements, not shown, typical of a small processor for example an arithmetical logic unit, associated registers and a memory. The memory includes memory locations, some of which are used to store an instruction set for controlling operations of the controller and property elements in the associated property. The processor 80 selects either of a receiving operation and a broadcasting operation via a control bus 91 connected as shown to the switch 90, the transmitter 83, and the receiver 70. A receiver portion of the controller includes the receiver 70, a code detector 74, a decoder 75, a data gate 77 and a level detector 76, connected as shown. The transmitter 83 is coupled to receive encoded data for broadcast from an encoder 82. The processor 80 is coupled via a data bus 86 to a register 81 and with an output of the encoder 82 as shown. The processor 80 effects control over the register 81 and the encoder 82 via a control lead 87. The processor 80 is also able to effect control of and read the status of the decoder 75 the level detector 76 and a property elements interface unit 93 via an input/output bus 85.

The receiver 70 functions during the receive operation by amplifying and demodulating signals which may have been broadcast by the fob. The code detector 74 examines a demodulated signal from the receiver 70 to determine if information contained therein includes predetermined information indicating the likely broadcaster to be the corresponding fob. At the same time a signal related to the strength of the received signal is coupled to the level detector 76. The decoder translates the demodulated signal into a data signal in format compatible with the processor 80. When such translation is complete the decoder 75 signals the level detector to the effect that decoding is complete. If the strength of the received signal exceeds a level having been predefined by the processor 80, the level detector enables the gate 77, which then asserts the data signal on a bus 84 for use by the processor 80. The processor 80 may redefine the level with which the level detector functions to be greater of lesser than the predefined level. If some time during a receive operation should the received signal strength fail to exceed the defined level, any resulting data signal is deemed to be unsuitable even if subsequently, the decoder signals that decoding is completed. In this event the gate 77 will not assert any signal on the data bus 84 and the receive operation continues, regardless.

The transmitter 83 functions in concert with the register 81, the encoder 82 and the switch 90 in an event where the processor 80 has an instruction to be sent to the fob. The instruction is registered by the register 81, preparatory to the instruction being encoded by the encoder 82. The encoder 82 generates a data word including a code intended to be unique to the associated fob and suitable for modulating a signal to be broadcast from the transmitter 83. When the transmitter 83 is keyed on, the data word is serially coupled to the transmitter 83 and results in a modulated signal being broadcast via the switch 90 and the antenna 71.

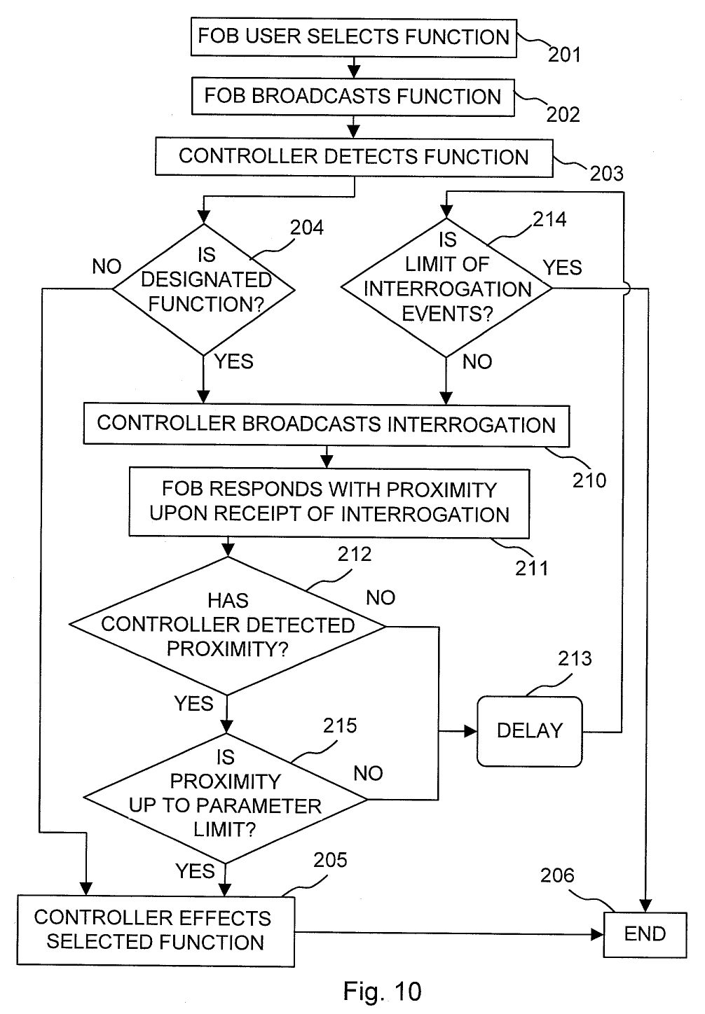

Referring to the flow diagram of FIG. 10, the function of a fob and a corresponding controller operating in concert are broadly illustrated. An example of a fob as illustrated in FIGS. 4 and 5 and a controller as illustrated in FIG. 7 are intended to operate in concert in accordance with the instruction sets stored in the respective memories of the processors 41 and 80. As previously described, when a user selects a function the fob broadcasts the function which when received is detected by the controller, as depicted in function blocks 201 202 and 203. In a decision block 204 if the detected function is not a designated function, the controller effects the selected function, as shown in a function block 205, and then ends the process as shown in a block 206. If however the detected function is a designated function, the controller broadcasts an interrogation signal intended for reception by the fob as shown in a function block 210, the fob responds by broadcasting a signal having a parameter which is useful for determining a proximity of the antennas of the fob and the controller, as required in a function block 211. In the example in FIG. 5 the parameter may be in a subsequent broadcast, which is monitored at the controller for signal strength. In one example battery power in the fob is conserved by broadcasting at a much reduced power, which requires the fob to be closely adjacent before a subsequent broadcast is detected by the controller.

In another example, the received signal strength of a subsequent broadcast must be much greater before the controller will act upon the designated function. In another example, not previously described, the signal parameter is based upon a time delay between interrogation and a proximity response, wherein a detected round trip propagation delay of broadcast interrogation and broadcast proximity signals shall be of less than a predesignated time. In yet another example, not previously described, the controller is aware of its position in terms of a geographical coordinate standard and likewise so is the fob, by means of a ground positioning system (GPS) receiver. In this example the fob responds by broadcasting a proximity signal including its instant geographical coordinates. No mater what particular arrangement is used, if subsequent to an interrogation broadcast the controller has not detected a proximity broadcast, as shown in a decision block 212 after a delay at a block 213, the controller rebroadcasts the interrogation in accordance with the function block 210, however contingent upon a limit of interrogation broadcasts having not yet occurred as is determined in a decision block 214. If the limit has been reached then the process ends at the block 206. If a proximity broadcast is received, contingent upon the proximity signal meeting a predetermined parameter limit as required in a decision block 215 the controller effects the selected function as shown in the function block 205. On the other hand if the required parameter is not fulfilled after the delay at 213 and having not yet met the limit at 214 the controller rebroadcasts the interrogation signal yet again as shown at the function block 210.

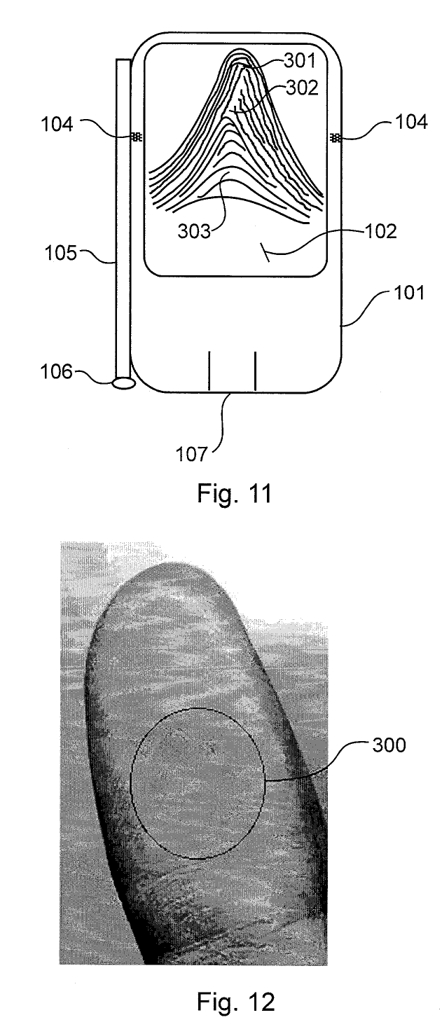

Referring to FIG. 11, the wireless portable biometric terminal is illustrated in near actual size, which is somewhat similar to the size of a credit card. The wireless portable biometric terminal includes a case 101, which includes a connector 107 suitable for coupling with a computer, not shown, via a universal serial bus (USB) for example. A display is provided by a monochrome liquid crystal (LCD) overlaid with a touch sensitive transparent capacitive array 102, which in concert with a processor, not visible within the case 101 provides a user interface. A pair of marks 104 at opposite sides of the display are intended to provide guidance for the user when presenting his or her finger for scanning by the wireless portable biometric terminal. One example of a capacitive array fingerprint sensor is disclosed in U.S. Pat. No. 4,353,056 wherein scanning is accomplished by sensing a change of voltage distribution in series connected capacitors or by measuring the voltage values of individual capacitances resulting from local induced voltages caused by the surface of a finger. If an observer could have a viewpoint looking out from under the capacitive array of the display 102, the observer would see the user's left hand middle digit pressed against the display similar to that illustrated in FIG. 12. Before the wireless portable biometric terminal is useful it must be personalized for the user's particular biometric information. This is accomplished with a computer operating with a fingerprinting application. A processor analyses and characterizes several individual fingertip scans provided to the biometric sensor. This may be done with any fingerprint scanner or the wireless portable biometric terminal may be so utilized while coupled via the USB connector 107 to the computer. Each scan is used to generate a template. One or more appropriate templates are registered for subsequent use as for example for comparing newly provided fingerprint and stored template for performing one of identifying and authorizing the provider of the fingerprint. The template or templates are registered in either of the wireless portable biometric terminal or a controller associated with the secured property for operation in concert with the wireless portable biometric terminal.

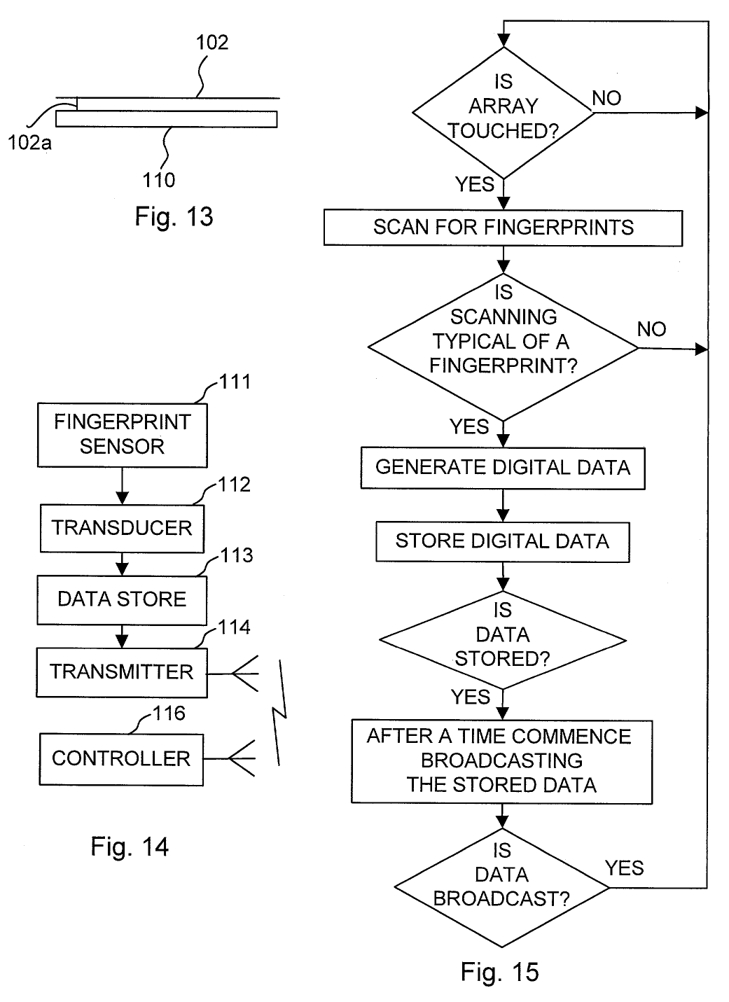

In FIG. 13, a simple example, similar to the wireless portable biometric terminal of FIG. 11, includes physical elements arranged as shown. The capacitive array 102 is carried adjacent encapsulated circuitry 110 and coupled thereto via a bus 102a. One example of the encapsulated circuitry 110 is illustrated in FIG. 14. The structure and operation of this example is discussed with reference to both FIGS. 14 and 15. The wireless portable biometric terminal includes a fingerprint sensor 111, a transducer 112, a data store 113 and a transmitter 114. An antenna coupled with the transmitter is shown to be in nearby juxtaposition with another antenna coupled with a controller 116, associated with a secure property, not shown. In operation the fingerprint sensor 111 detects change of capacitive charges in the capacitive array 102. If the capacitive array 102 is touched, the fingerprint sensor 111 effects a scanning function. Signals representing changes of capacitive charges in the array are transferred to the transducer 112. If the signals are generally of a character representing the typical ridges and valleys of a fingerprint, the transducer 112 generates a stream of digital data, which is accepted by and stored in the data store 113. The data store 113 can be conveniently provided by a random access memory and associated memory management circuitry. After the stream of the digital data is stored, a code for addressing the controller 116 is read out from the data store 113 to the transmitter 114 followed by a readout of the digital data stream. The readout occurs at a rate appropriate for modulating a broadcast signal, intended for reception by the controller 116. If the digital data stream is received at the controller 116 and is sufficiently representative of one or more preregistered templates, the controller initiates the appropriate function. When broadcasting from the transmitter 114 is complete the wireless portable biometric terminal is again ready to accept a biometric characteristic.

In this example the readout occurs an interval of time after the stream of the digital data has been stored. The interval of time permits a user, carrying the wireless biometric terminal to progress from a location where they presented their fingerprint, toward a location of their locked vehicle. In other words the interval of time is chosen to be that convenient for the user to have presented their fingerprint at a convenient place and time prior to a time of a consequent effect thereof at said property. Hence the problems in sensing a print of a finger, which is cold, hot, wet or overly dry tend to be avoided, while a premature unlocking of the associated property is unlikely.

Operation of the transmitter 114 can be a major consumer of battery power. In one example, consumption of battery power is reduced by broadcasting at a very low power. After a time interval of say half a minute so, the data store 113 and the transmitter 114 are activated momentarily to broadcast the data stream modulated signal at say 2 second intervals for the next half minute. This permits the user carrying their wireless portable biometric terminal to approach the property before broadcasting of an entry function begins. Optionally, the timings are predetermined by hardware or firmware at the time of manufacture, or alternately are assigned during the initialization of the wireless portable biometric terminal via the connector 107.

In another example the templates have been preregistered in the wireless portable biometric terminal such that only a function code intended for the controller 116 need be broadcast, following verification of the user's fingerprint. Of course, verification of the user's fingerprint requires additional data processing and a consequent increase in battery power consumption, however as each individual broadcast signal is of comparatively shorter duration, the additional data processing and consequent battery power consumption is more than compensated.

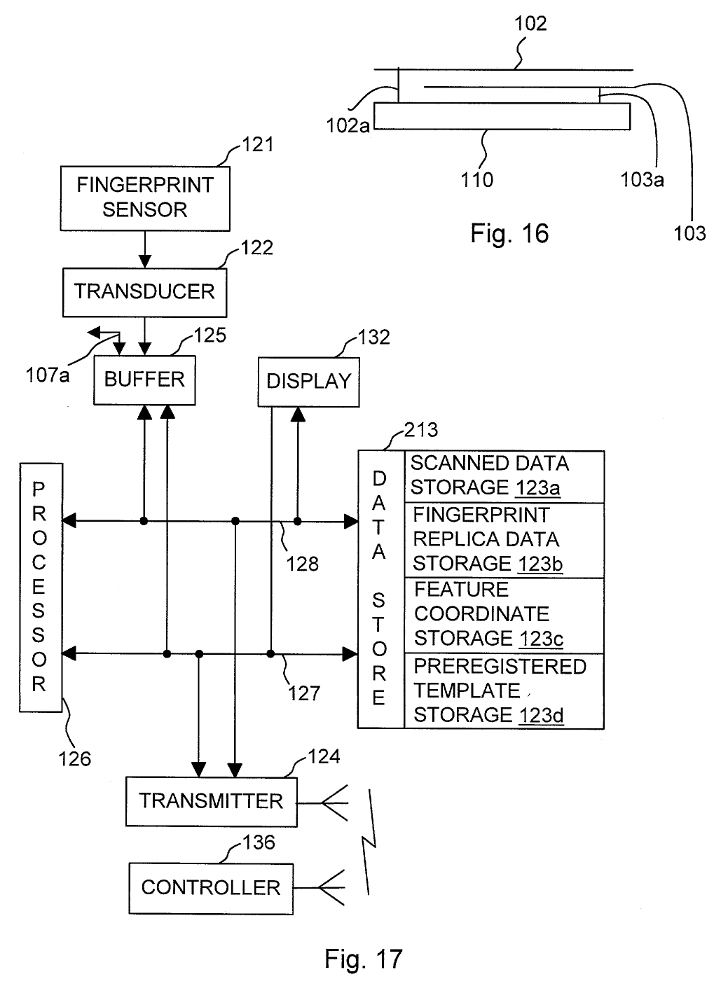

Referring to FIGS. 11 and 16, a display 103 in the form for example of a graphical display, beneath the capacitive array 102, avails the user of several different features that are selectable via the display 103. In this example a sheath 105 at one side of the case 101 contains a stylus with a knobby end 106 protruding as shown. The user withdraws the stylus from the sheath and uses the tip of the stylus to point touch the display location of the user's intended selection, for example at any of locations labeled 301, 302 and 303. The processor responds to the point touch information presented to the capacitive array by causing a corresponding signal to be broadcast in the manner as before described.

When a user's biometric information is determined to be acceptable, a replica of a portion of the user's fingerprint, corresponding to an area indicated at 300 in FIG. 12, is displayed. Here the data is show with the valleys in black in a fashion opposite to a typical inked fingerprint. In this example during initialization of the wireless portable biometric terminal, the user and the computer operator in collaboration have preassigned several distinctive portions of the finger pattern, for example those portions labelled 301, 302 and 303, as being related to corresponding operable elements at the property. Subsequently, responsive to the user presenting the appropriate finger to the array 102, the data is displayed. As before described the stylus is used by point touching the portion of the displayed data known to the user to correspond to the desired function. The processor responds by causing a corresponding signal to be broadcast. The user is permitted to be at some distance from the property, conveniently sheltered from inclement weather when effecting the selection. Subsequent initiation of operation of a function may be more or less immediate but when the function is that of gaining access to the property such may be limited to occurring only if the fob is closely adjacent the property.

If, for example, when the wireless portable biometric terminal is initialized the portions labelled 301, 302 and 303 are assigned as a ‘remote start’ function, an ‘unlock immediate’ function and a ‘secure unlock’ function, respectively. A user selection of either of the portions labelled 301 and 302 will cause a transmitter in the wireless portable biometric terminal to broadcast the appropriate signal at a standard power. A user selection of the portion labelled 303, corresponding to the ‘secure unlock’ function, is expected to be most frequently used and is broadcast at a later time, repeatedly, at a reduced power.

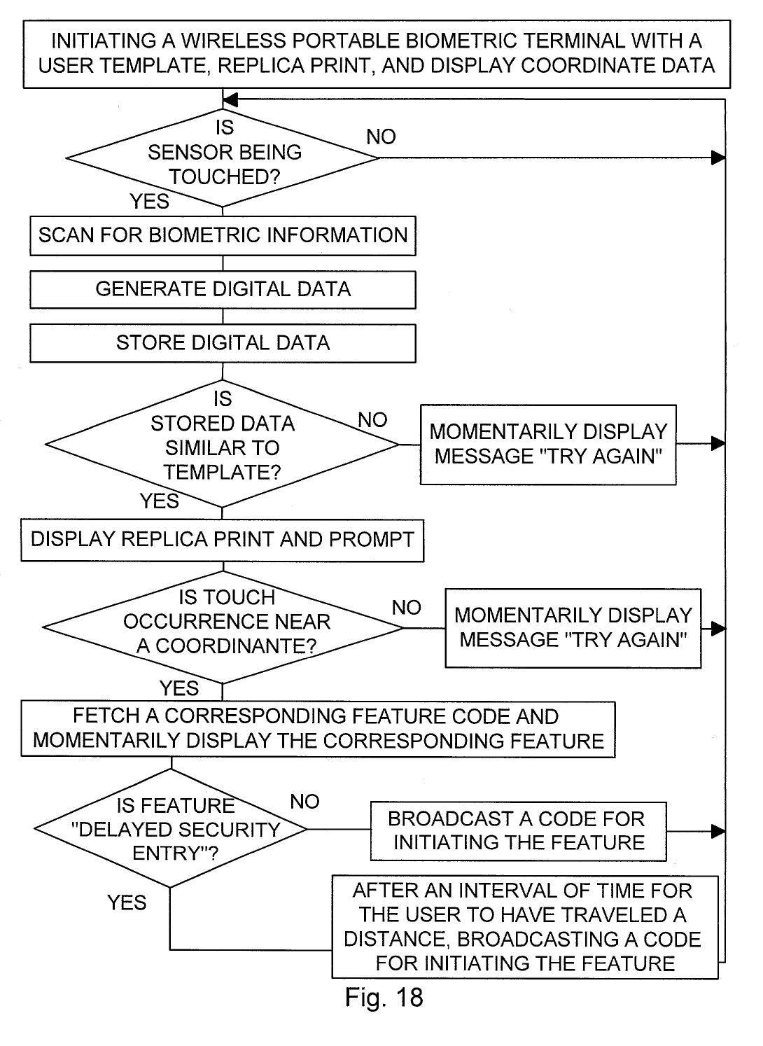

FIG. 16 illustrates a physical arrangement of elements in the wireless portable biometric terminal of FIG. 11. Here, the monochrome LCD is labelled 102 and is shown to be located adjacent circuitry 110a and coupled thereto via its bus 102a. The capacitive array 103 is carried on a surface of the LCD 102 and connected to the circuitry 110a via its bus 103a. One example of the circuitry 110a is illustrated in FIG. 17. The structure and operation of this example of the wireless portable biometric terminal is discussed with reference to FIGS. 17 and 18. The wireless portable biometric terminal includes a display 132, a fingerprint sensor 121, a transducer 122, a buffer 125, a data store 123, a transmitter 124, a processor 126, a control bus 127, and a data bus 128, connected as shown. The data store 123 is provided by a random access memory having an area of storage locations 123a for storing scanned data, an area of storage locations 123b for storing a fingerprint replica data, an area of storage locations 123c for storing feature coordinates, and an area of storage locations 123d for storing data representing one or more preregistered templates. The buffer 125 is also coupled to the USB connector 107, shown in FIG. 11, via a bus 107a. An antenna coupled with the transmitter is illustrated as being nearby another antenna coupled with a controller 136, normally associated with a secure property, not shown.

Before the wireless portable biometric terminal is useful it is personalized with at least one template for use in identifying the user's fingerprint, fingerprint replica data suitable for display and a plurality of feature coordinates. In operation the fingerprint sensor 211 detects changes of capacitive charges in the capacitive array 103. If the capacitive array 103 is touched, the fingerprint sensor 121 effects a scanning function. Signals representing changes of capacitive charges in the array are transferred to the transducer 122. The transducer 122 generates a stream of digital data that begins to be accumulated in the buffer 125 until the processor 216 causes the data store 123 to accept and store the data from the buffer 125. The processor 126 examines the data having reference to the templates to ascertain whether or not there is a similarity. If there is insufficient similarity—NO, the processor causes a momentary display of a message such as “Try Again”. If YES, the processor 126 causes the replica print to be displayed along with a momentary prompt for the user to “Point to Feature”, or some such message. At this time the user is expected to use the styles to touch the display near one of the areas the user remembers to have been assigned to the desired function. If the touch occurrence fails to correspond to one of the coordinates or fails to occur in a short time, the momentary message “Try Again” is displayed and the terminal resumes monitoring the sensor for a finger touch occurrence. If the touch occurrence corresponds to a one of the coordinates the corresponding feature code is examined to see if it specifies a delayed security feature. If not—NO, the processor 126 causes the feature code to be broadcast by the transmitter 124, for reception by the controller 126. However if YES, the code specifies a delayed security entry feature. The feature code will be broadcast periodically at low power after a time intended to permit the user to have progressed toward the vehicle or property.

In another example, very low battery power consumption is achieved with the use of a repeater transmitter 1009, installed within the vehicle 1000 in FIG. 1. The repeater transmitter 1009 is powered from the vehicles battery, not shown, and hence its power consumption is of no practical consequence. The user's terminal transmits the a feature code signal at very low power only once to the repeater transmitter which in turn broadcasts the feature code signal for reception by the controller in the residence 1010. The broadcast can be either immediate or delayed as either is predetermined or selected by the user. In this case with reference to FIG. 11, the feature code corresponding to location 301 may be to unlock the door 1011. After selection by the user as previously described, the user leaves the vehicle and if the time interval has been optimally selected, the door 1011 will be unlock when the user is almost at the door.

As before mentioned it is common knowledge to those of skill in the art in electronic biometric information sensing and analysis, that a significant problem exists in sensing fingerprints in extreme environmental conditions. Wet fingertips in contrast to dry fingertips are imaged differently by contact imagers such as the capacitive array 103. Even more significant are problems associated with imaging of overly dry fingertips such as those resulting from extremely cold weather. Unfortunately, cold weather is a reality to contend with in many locations as is humidity. Inside environments such as those of the residence 1010 and the vehicle 1000 exemplified in FIG. 1, are usually controlled and thus unlikely to subject the user to such temperature and humidity extremes. As described in the foregoing the invention permits the user to be in a controlled or more agreeable environment while presenting his or her biometric information. Accordingly, scans of the user's fingerprint are more functionally accurate in such controlled atmospheres. In this example the user will usually be at some distance from the property for which access is desired. If battery power is to be conserved, the broadcast signal is preferably of low power and broadcasting will not commence until sometime has passed permitting the user to have progressed toward their vehicle, residence, or other property, as the case may be.

Alternatively, when the fob includes a biometric imaging device, the template matching is performed at the port such that the image, portions thereof, or characteristics extracted therefrom are provided for transmission. Once received, the transmitted data is possibly further analysed and then compared to templates to determine user authorization.

Though in the above embodiments, the time interval between selecting a function and actuating said function is predetermined or determined based on a received signal from a receiver, the signal may also be received from a user who, upon approaching an actuation location presses a generic input device or button. Optionally, once data is stored within the fob for transmission, actuation of any input switch on the fob results in transmission of the signal. This supports providing a fingerprint, for example, in a warm car and then crossing the parking lot outside and only transmitting the fingerprint or the access code when proximate an entry to a building. Thus, the cold will not affect the fingerprint imaging and will not affect the user.

Further preferably, the fob erases any received secure input data once it is processed or transmitted to prevent access to the data by other than authorized individuals.

In an embodiment, there is provided for further data input by allowing a user to indicate one or more features within a visual representation of their biometric information. When used with fingerprint data, a single selected feature is useful in place of the core as a translationally invariant feature. Two features provided in order are useful in determining a vector being a rotationally and translationally invariant feature. Of course, for multi-dimensional data, further features are optional.

Of course, the additional features could be used instead or as well to form a password, to select a predetermined function or access code, or to select a process for use in analyzing the biometric data.

Though it would be most secure to require a user to accurately reselect an identical location within the displayed data, such an embodiment is typically not practical. Therefore, a selection is associated with a nearest feature. Alternatively, features are extracted and highlighted to allow easy selection of one of the N extracted features. Preferably, features in very close proximity are highlighted as a single feature or are represented by only one highlighted feature.

In the forgoing disclosure various examples of keyless and remote activation for features resident in a static property or a vehicular property have been discussed wherein a fob is in communication with a controller over distances of up to say 100 metres or more. Particularly a distinction is made between a function desirably initiated at an instant of a communicated selection and an access related function for which actuation is subsequent to a determination that the fob is closely adjacent, a few metres for example. Readers of the foregoing discloser will envision various embodiments within the spirit and scope of the present invention.

What is claimed is:

1. A wireless portable terminal for operation in concert with a controller within a property, the terminal comprising:
a biometric transducer for accepting a biometric information sample provided by a user and for generating digital data based on at least a characteristic of the biometric information sample;
a data store for storing the digital data generated by the biometric transducer; and,
a transmitter being responsive to the digital data having been stored in the data store for transmitting a signal, at a predetermined frequency and modulated based on the stored digital data for reception by the controller, after an interval of time corresponding to a time for the user carrying the wireless portable terminal to have traveled a distance, such that the user may present a predetermined biometric characteristic at a convenient place and time prior to the time of a consequent effect thereof at said property.

2. A wireless portable terminal as defined in claim 1 wherein said biometric information sample is that of a fingerprint of the user and wherein the transmitter is a portable device for being ported by the user.

3. A wireless portable terminal as defined in claim 2 comprising a timer and wherein the interval of time is predetermined interval of time.

4. A wireless portable terminal as defined in claim 3 wherein the transmitter is for repeatedly transmitting the signal for the predetermined interval of time.

5. A wireless portable terminal as defined in claim 3 wherein the transmitter is for transmitting the signal once at an expiry of the predetermined interval of time.

6. A wireless portable terminal as defined in claim 2 comprising an actuator and wherein the signal is for being transmitted in response to actuation of the actuator after the interval of time.

7. A wireless portable terminal as defined in claim 6 wherein the actuator is for receiving actuation input data other than the biometric information provided to the device and wherein the data within the data store is transmitted upon receiving the actuation input data.

8. A wireless portable terminal as defined in claim 6 comprising a data deletion circuit for erasing the digital data within the data store after transmission thereof.

9. A wireless portable terminal as defined in claim 1 comprising a data deletion circuit for erasing the digital data within the data store after transmission thereof is completed.

10. A wireless portable terminal as defined in claim 2 comprising a receiver wherein the interval of time is ended based on receiving a signal from the property, the signal for being received within a known proximity to the property of the wireless portable terminal.

11. A wireless portable terminal as defined in claim 10 wherein the signal is modulated in dependence upon the received signal.

12. A wireless portable terminal as defined in claim 1 comprising a receiver wherein the interval of time is ended based on receiving a signal from the property, the signal for being received within a known proximity to the property of the wireless portable terminal.

13. A wireless portable terminal as defined in claim 12 wherein the signal is modulated in dependence upon the received signal.

14. A wireless portable terminal as defined in claim 1 wherein the signal is modulated by the stored digital data.

15. A wireless portable terminal as defined in claim 1 comprising
a processor for processing the stored digital data and for comparing the stored digital data and stored template data relating to at least an authorized user; and wherein upon the user being one of the at least an authorized user, the transmitted signal is modulated with user authorization data stored within the terminal.

16. A wireless portable terminal as defined in claim 15 wherein the data is an access code.

17. A method of operating a wireless portable terminal for communicating with a controller within a property, upon a presentation of a user's biometric characteristic thereto, comprising the steps of:
accepting a biometric information having been presented by a user;
generating a digital data representative of the biometric information;
storing the digital data having been generated; and,
responsive to the digital data having been stored and after an interval of time corresponding to a time for the user of the entry terminal to have traveled a distance, broadcasting a signal, at a predetermined frequency being modulated based on the stored digital data for reception by the controller, such that the user may present a predetermined biometric characteristic at a convenient place and time prior to the time of a consequent effect thereof at said property.

18. A method according to claim 17 wherein the interval of time is predetermined by a timer.

19. A method according to claim 18 wherein the signal based on the stored digital data is transmitted at expiry of the predetermined interval of time.

20. A method according to claim 18 wherein the signal based on the stored digital data is transmitted for the interval of time predetermined by the timer.

21. A method according to claim 17 comprises the step of deleting the stored digital data representative of the biometric information presented by the user.

22. A method according to claim 17 wherein the step of broadcasting the signal comprises the step of providing an actuation signal to an actuator, the actuating signal being other than the stored digital data representative of the biometric information.

23. A method according to claim 22 comprises the step of deleting the stored digital data representative of the biometric information upon actuation of the actuator.

24. A method according to claim 22 comprises the step of deleting the stored digital data representative of the biometric information upon transmission of the signal.

25. A method according to claim 22 wherein the actuation signal is transmitted to a receiver.

26. A method according to claim 17 wherein the generated digital data representative of the biometric information is an access code.

27. A method according to claim 17 wherein the generated digital data representative of the biometric information is a digital representation of the biometric information.

28. A wireless portable terminal for operation in concert with a controller within a property, the terminal comprising:
a transducer for accepting input data provided by a user and for generating digital data based on the input data;
a data store for storing the digital data generated by the biometric transducer; and,
a transmitter being responsive to the digital data having been stored in the data store for transmitting a signal, at a predetermined frequency and modulated based on the stored digital data for reception by the controller, after an interval of time corresponding to a time for the user carrying the wireless portable terminal to have traveled a distance, such that the user may present a predetermined biometric characteristic at a convenient place and time prior to the time of a consequent effect thereof at said property.
